(19) United States
(12) Patent Application Publication
(10) Pub. No.: US 2024/0081290 A1
(43) Pub. Date: Mar. 14, 2024

(54) ANIMAL LEASH

(71) Applicant: Christopher Palmerton, Virginia Beach, VA (US)

(72) Inventor: Christopher Palmerton, Virginia Beach, VA (US)

(21) Appl. No.: 17/940,699

(22) Filed: Sep. 8, 2022

(51) Int. Cl. A01K 27/00

(52) U.S. Cl. CPC A01K 27/003

(57) ABSTRACT

An animal leash, including a main body having an elongate shape, the main body including a first loop disposed on at least a portion of a first end of the main body to removably connected to at least a portion of a body of an animal, and a second loop disposed on at least a portion of a second end of the main body to facilitate gripping thereof, a connecting ring movably disposed on at least a portion of the first end of the main body to adjust a size of the first loop in response to moving along a length of the main body, and a rivet tab disposed on at least a portion of the main body to prevent the connecting ring from moving beyond a position of the rivet tab.

### BACKGROUND

### 1. Field

The present general inventive concept relates generally to a leash, and particularly, to an animal leash.

### 2. Description of the Related Art

A slip lead is a type of leash that combines a leash and a collar in one easy-to-use design accessory for controlling an animal, such as a dog. In other words, a pet owner needs to only have the slip lead to walk the animal instead of having two separate items.

However, most slip leads are made with a leather material stopper which has a tendency of eroding and causing the leash to slip. Also, the crimps on slip leads are typically sown together with threads. A slipped leash can be stressful for both the pet owner and the animal because the pet owner has to repeatedly readjust the positioning of the leash with respect to a stopper.

Therefore, there is a need for an animal leash that has a sturdy stopper constructed of stronger material and keeps the animal connected.

### SUMMARY

The present general inventive concept provides an animal leash.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an animal leash, including a main body having an elongate shape, the main body including a first loop disposed on at least a portion of a first end of the main body to removably connected to at least a portion of a body of an animal, and a second loop disposed on at least a portion of a second end of the main body to facilitate gripping thereof, a connecting ring movably disposed on at least a portion of the first end of the main body to adjust a size of the first loop in response to moving along a length of the main body, and a rivet tab disposed on at least a portion of the main body to prevent the connecting ring from moving beyond a position of the rivet tab.

The main body may be coated with a fragrance based on a type of the animal to calm the animal.

The rivet tab may be constructed of thermoplastic acrylic-polyvinyl chloride.

The animal leash may further include a plurality of crimps disposed on at least a portion of the main body to connect the first end of the main body to a first portion of the main body and the second end of the main body to a second portion of the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of an animal leash, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Animal Leash 100
Main Body 110
First Loop 111
Second Loop 112
Connecting Ring 120
Rivet Tab 130
Crimps 140

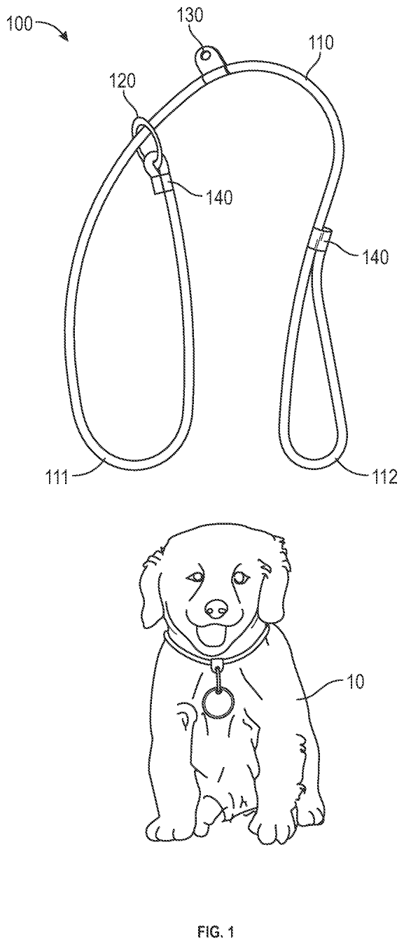

FIG. 1 illustrates a side perspective view of an animal leash 100, according to an exemplary embodiment of the present general inventive concept.

The animal leash 100 may be constructed from at least one of metal, plastic, wood, and rubber, etc., but is not limited thereto.

The animal leash 100 may include a main body 110, a connecting ring 120, a rivet tab 130, and a plurality of crimps 140, but is not limited thereto.

The main body 110 may be constructed of polyester, which is comfortable for hands and/or an animal 10.

The main body 110 may have an elongate shape and may have any length, such as six or seven inches. Moreover, the main body 110 may be a cord, a string, a rope, a twine, and/or a slip lead, but is not limited thereto. The main body 110 may be rigid, such that the main body 110 may have a fixed shape and/or a fixed size. Alternatively, the main body 110 may be flexible to at least partially deform (e.g., bend, stretch, expand) on at least a portion of an entire length of the main body 110.

The main body 110 may include a first loop 111 and a second loop 112, but is not limited thereto.

The first loop 111 may be disposed on at least a portion of a first end of the main body 110. Additionally, the first loop 111 may be removably connected to at least a portion of a body of the animal 10. For example, the first loop 111 may be disposed around a neck of the animal 10.

The second loop 112 may be disposed on at least a portion of a second end of the main body 110 opposite with respect to the first end. Moreover, the second loop 112 may be worn and/or held by a user (e.g., an owner of the animal 10, an animal walker). As such, the second loop 112 may facilitate gripping thereof.

It is important to note that a size (e.g., a length, a width, a diameter) of the first loop 111 may be adjustable. However, a size of the second loop 112 may be fixed. Alternatively, the second loop 112 may also be adjustable depending on a preference of the user.

Furthermore, the main body 110 may be coated with a fragrance designed to calm the animal 10. For example, the fragrance may be designed for a dog and/or a cat, but different depending on a type of the animal 10.

Referring to FIG. 1, the connecting ring 120 is illustrated to be a ring. However, the connecting ring 120 may be an type of fastener, such as a clamp, a clasp, a carabiner, and a hook, but is not limited thereto.

The connecting ring 120 may be disposed on at least a portion of the first end of the main body 110. The connecting ring 120 may connect the first end of the main body 110 to a center portion of the main body 110, such that the first loop 111 is formed. Also, the connecting ring 120 may move (i.e., slide) along at least a portion of a length of the main body 110. As such, the size of the first loop 111 may adjust in response to movement of the connecting ring 120 along the length of the main body 110.

More specifically, the first loop 111 may increase in size in response to the connecting ring 120 moving away from the first end of the main body 110. Conversely, the first loop 111 may decrease in size in response to the connecting ring 120 moving toward the first end of the main body 110.

The rivet tab 130 may be constructed of thermoplastic acrylic-polyvinyl chloride. As such, the rivet tab 130 may be rigid and/or highly resistant to abrasion and/or damage.

The rivet tab 130 may be disposed on at least a portion of the main body 110. The rivet tab 130 may prevent the connecting ring 120 from moving beyond a position of the rivet tab 130. Accordingly, the rivet tab 130 may be a stopper, such that the first loop 111 may remain disposed on the animal 10 instead of being enlarged and/or being removed from the animal 10.

Each of the plurality of crimps 140 may be constructed of metal, such as copper.

The plurality of crimps 140 may be disposed on at least a portion of the main body 110. A first of the plurality of crimps 140 may be disposed on at least a portion of the first end of the main body 110 and a second of the plurality of crimps 140 may be disposed on at least a portion of the second end of the main body 110. Each of the plurality of crimps 140 may connect the first end of the main body 110 and/or the second end to the main body 110 to form a smaller loop. For example, the first of the plurality of crimps 140 may form the smaller loop to receive the connecting ring 120 therethrough. As such, the plurality of crimps 140 may fasten the first end of the main body 110 and/or the second end of the main body 110 to the main body 110.

Therefore, the animal leash 100 may provide a strong slip lead that is not prone to wear. Also, the animal leash 100 may keep the animal 10 connected without risk of detachment.

The present general inventive concept may include an animal leash 100, including a main body 110 having an elongate shape, the main body 110 including a first loop 111 disposed on at least a portion of a first end of the main body 110 to removably connected to at least a portion of a body of an animal 10, and a second loop 112 disposed on at least a portion of a second end of the main body 110 to facilitate gripping thereof, a connecting ring 120 movably disposed on at least a portion of the first end of the main body 110 to adjust a size of the first loop 111 in response to moving along a length of the main body 110, and a rivet tab 130 disposed on at least a portion of the main body 110 to prevent the connecting ring 120 from moving beyond a position of the rivet tab 130.

The main body 110 may be coated with a fragrance based on a type of the animal 10 to calm the animal 10.

The rivet tab 130 may be constructed of thermoplastic acrylic-polyvinyl chloride.

The animal leash 100 may further include a plurality of crimps 140 disposed on at least a portion of the main body 110 to connect the first end of the main body 110 to a first portion of the main body 110 and the second end of the main body 110 to a second portion of the main body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An animal leash, comprising:
a main body having an elongate shape, the main body comprising:
a first loop disposed on at least a portion of a first end of the main body to removably connected to at least a portion of a body of an animal, and
a second loop disposed on at least a portion of a second end of the main body to facilitate gripping thereof;
a connecting ring movably disposed on at least a portion of the first end of the main body to adjust a size of the first loop in response to moving along a length of the main body; and
a rivet tab disposed on at least a portion of the main body to prevent the connecting ring from moving beyond a position of the rivet tab.

2. The animal leash of claim 1, wherein the main body is coated with a fragrance based on a type of the animal to calm the animal.

3. The animal leash of claim 1, wherein the rivet tab is constructed of thermoplastic acrylic-polyvinyl chloride.

4. The animal leash of claim 1, further comprising:
a plurality of crimps disposed on at least a portion of the main body to connect the first end of the main body to a first portion of the main body and the second end of the main body to a second portion of the main body.
